(19) United States
(12) Patent Application Publication
(10) Pub. No.: US 2006/0112832 A1
(43) Pub. Date: Jun. 1, 2006

(54) Coffee maker with mechanical coffee level indicator

(75) Inventors: James R. Barraclough, Waterbury, CT (US); Theodore B. Mulle, New Milford, CT (US); Barbara L. Schnabel, Chappaqua, NY (US)

Correspondence Address: STEVEN A. GARNER;CONAIR CORPORATION, ONE CUMMINGS POINT ROAD, STAMFORD, CT, 06902, US

(73) Assignee: CONAIR CORPORATION

(21) Appl. No.: 10/998,698

(22) Filed: Nov. 29, 2004

(51) Int. Cl. C12C 11/00

(52) U.S. Cl. 99/276

(57) ABSTRACT

There is provided a coffee maker having a housing with a lid and a base, a control panel for operating the coffee maker, a coffee dispenser, an actuator for dispensing the coffee into a cup or container and a removable drip tray to catch any spilling of the coffee. Within the coffee maker is a fresh water reservoir to hold water to be heated, a heater to heat the water, a filter basket to hold the coffee grinds to be brewed, a water spreader to distribute the heated water into the filter basket, and a brewed coffee reservoir to hold the brewed coffee that drips from the filter basket. A secondary heater can be located within the brewed coffee reservoir to keep the brewed coffee warm. The coffee maker features a mechanical coffee level indicator. The indicator consists of a pivoted arm, a float and an indication gauge. The gauge is located on the front panel of the coffee maker and indicates how much coffee remains in the coffee holding reservoir. The mechanism works by having a lever connecting to a float, which floats on the surface of coffee. As the float rises or falls, the lever causes a gear system to rotate. This gear system then rotates an indication needle, which indicates the amount of coffee within the coffee reservoir.

### CROSS-REFERENCE TO RELATED APPLICATIONS

None.

### BACKGROUND OF THE INVENTION

1. Field of the Invention

The present invention relates to a coffee maker and, more particularly, to a coffee maker with a mechanical coffee level indicator, especially of the type that includes a float and an indication needle within a gauge to indicate the amount of coffee remaining in a coffee holding reservoir.

2. Description of Related Art

It is well known in the art to use certain standard components in a coffee maker such as a water reservoir, from which water travels to a heating system where it is boiled. The heated water then travels through internal tubing, a water spreader, and to a coffee filter basket. Within the filter basket is an amount of coffee. The heated water drains through the coffee and into a coffee holding reservoir. The brewed coffee is kept warm in the holding reservoir by means of a secondary heater that is positioned on the floor of the coffee reservoir.

In order to allow a user to determine the amount of brewed coffee within the device, a transparent window on the coffee holding reservoir can be used. A vertical slot on the side of the holding reservoir can also be used. However, these windows and slots give a somewhat rough estimate of how much coffee remains and often do not give a clear indication of the exact amount. In addition, the amount of coffee remaining in the coffee maker is often difficult to gauge as the coffee may be difficult to see against the background of the coffee maker which is often somewhat similar in color to the coffee itself.

There is a need, therefore, for a coffee level indicator that is accurate, reliable and clearly indicates the amount of brewed coffee remaining in the holding reservoir.

### BRIEF SUMMARY OF THE INVENTION

It is an object of the present invention to overcome the shortcomings of the prior art mentioned above. These and other objects are achieved by the present invention described herein.

The preferred embodiment of the present invention is directed to a coffee maker having a housing with a lid and a base, a control panel for operating the coffee maker, a coffee dispenser, an actuator for dispensing the coffee into a cup or container and a removable drip tray to catch any spilling of the coffee. Within the coffee maker is a fresh water reservoir to hold water to be heated, a heater to heat the water, a filter basket to hold the coffee grinds to be brewed, a water spreader to distribute the heated water into the filter basket, and a brewed coffee reservoir to hold the brewed coffee that drips from the filter basket. A secondary heater can be located within the brewed coffee reservoir to keep the brewed coffee warm.

The present invention features a mechanical coffee level indicator. The indicator consists of a pivoted arm, a float and an indication gauge. The gauge is located on the front panel of the coffee maker and indicates how much coffee remains in the coffee holding reservoir. The mechanism works by having a lever connecting to a float, which floats on the surface of coffee. As the float rises or falls, the lever causes a gear system to rotate. This gear system then rotates an indication needle, which indicates the amount of coffee within the coffee reservoir.

### BRIEF DESCRIPTION OF THE DRAWINGS

The present invention is more fully understood by reference to the following detailed description of an illustrative embodiment with the drawings identified below.

FIG. 1 is a perspective view of a preferred embodiment of a coffee maker in accordance with the present invention.

FIG. 2 is a perspective view of the coffee maker shown in FIG. 1 with the lid in the open position and with a partial cut-out view of a preferred embodiment of a mechanical coffee level indicator.

FIG. 3 is a side elevation cross-sectional view of the coffee maker shown in FIG. 1.

FIG. 4 is a perspective view of a preferred embodiment of a mechanical coffee level indicator.

FIG. 5 is a perspective view of the preferred embodiment of a mechanical coffee level indicator in FIG. 4 within a support frame.

FIG. 6 is a partial front elevation cross-sectional view detailing the mechanical coffee level indicator and support frame within the coffee maker shown in FIG. 1.

### DETAILED DESCRIPTION OF THE INVENTION

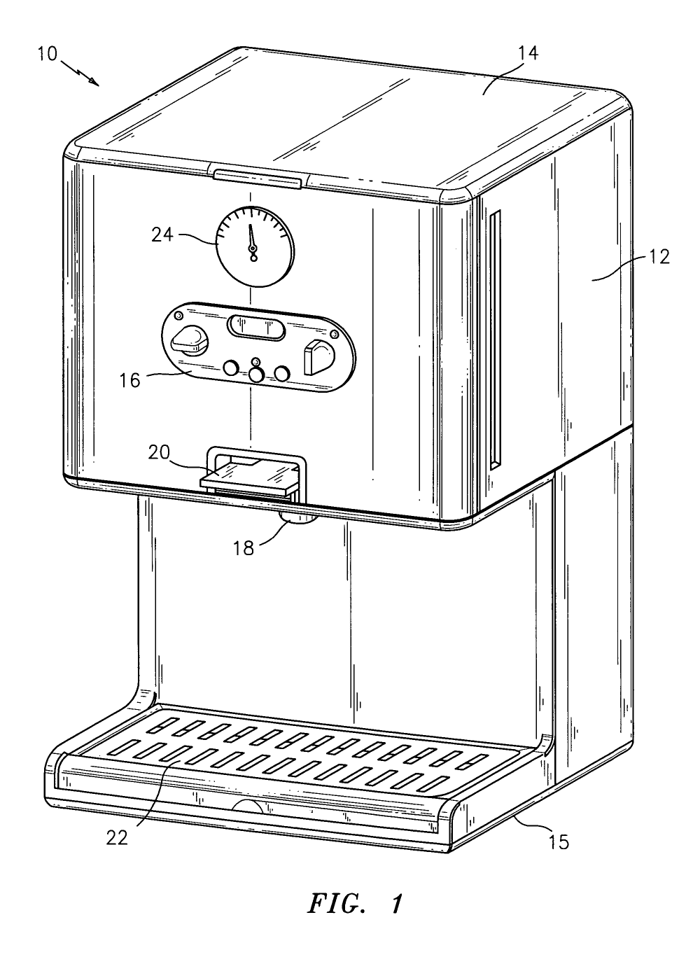

Referring to FIGS. 1 through 6, the preferred embodiment of the present invention, as directed to a coffee maker, is illustrated. As shown in FIG. 1, the coffee maker 10 includes a housing 12 with a lid 14 and a base 15, a control panel 16 for operating the coffee maker 10, a coffee dispenser 18, an actuator 20 for dispensing the coffee and a removable drip tray 22 to catch any spilling of the coffee. The control panel 16 can allow a user to operate the coffee maker 10 in a variety of ways. The coffee maker can, for example, be programmed to operate for a particular length of time or have a certain start and/or stop time. The coffee maker 10 can have a clock with various alarms. The coffee maker 10 also features a coffee level indicator 24, which will be described in further detail below.

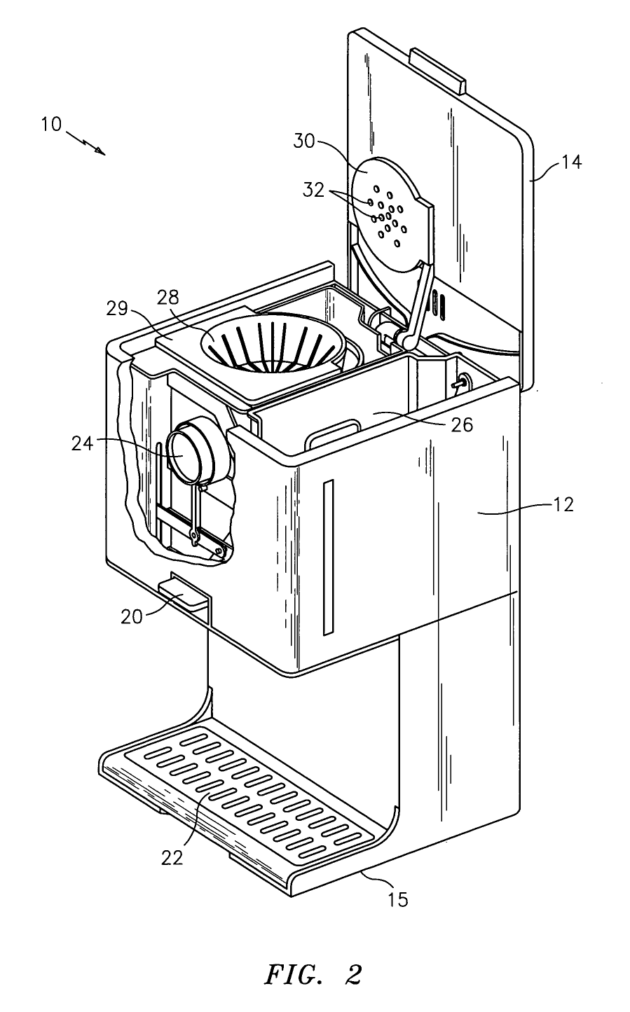

As shown in FIG. 2, within the housing 12 is located a fresh water reservoir 26 to hold the water to be heated. The water reservoir 26 is easily removable so that it may be cleaned. Adjacent the water reservoir 26 is a filter basket 28, which holds the ground coffee that will be brewed. This filter basket 28 sits within a coffee filter basket holder 29 and is also removable for easy cleaning. Covering both the water reservoir 26 and the filter basket 28, the lid 14 is rotatably connected to the back wall of the housing 12. Connected to the lid 14 is the water spreader 30, which contains apertures 32 for distributing the heated water into the filter basket 28. The water spreader 30 rotates along with the lid 14.

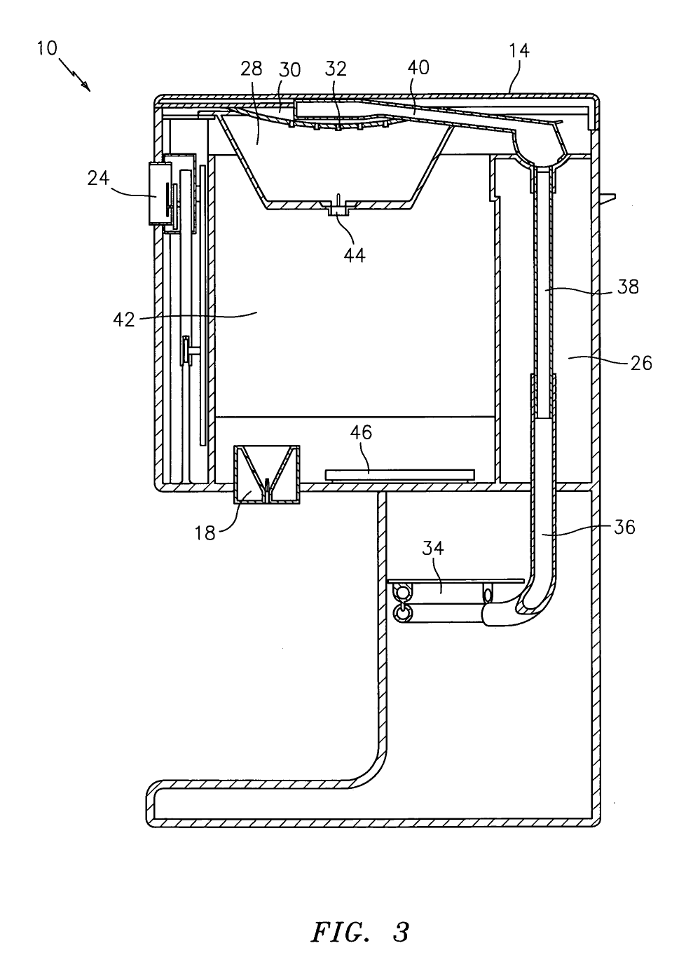

FIG. 3 shows a cross-sectional view of the coffee maker 10. Below the fresh water reservoir 26 is a hot water heater 34, which heats the water from the water reservoir 26. Connected to the water heater 34 is a hot water tube 36. The hot water tube 36 carries the hot water from the water heater 34 to a pipe 38, and onto the water spreader 30 via an arm 40, which connects the pipe 38 to the water spreader 30.

Located below the filter basket 28 is the brewed coffee reservoir 42. The coffee reservoir 42 holds the brewed coffee that drips from the filter basket 28 to the coffee reservoir though a basket opening 44. Within the coffee reservoir is a secondary heater 46 that keeps the coffee hot. The brewed coffee remains in the coffee reservoir 42 until it is to be consumed. On the front of the housing 12 is a coffee level indicator 24 to show the amount of brewed coffee remaining in the coffee reservoir 42.

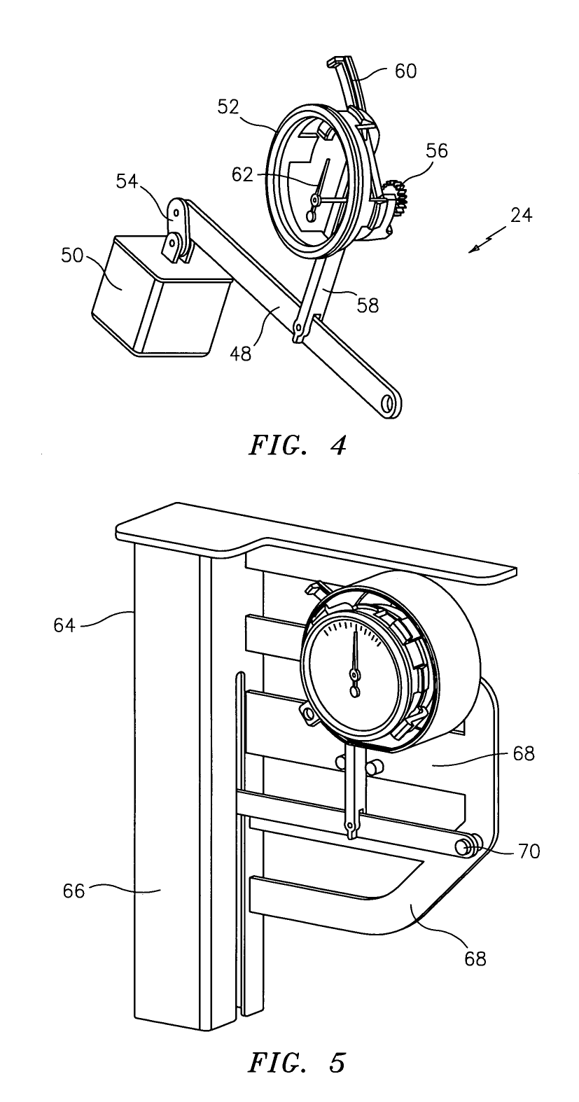

FIG. 4 shows the coffee level indicator 24, which consists of a lever 48, a float 50 and an indication gauge 52. The float 50 is connected to the lever 48 by a link 54. This link 54 allows the lever 48 to pivot at various angles with respect to the float 50. The float 50 could be made out of any material that would enable it to float on the surface of coffee. The lever 48 is connected to a gear system 56 though a first rod 58 and a second rod 60. The gear system 56 is connected to an indication needle 62 within the gauge 52 to show the amount of coffee remaining.

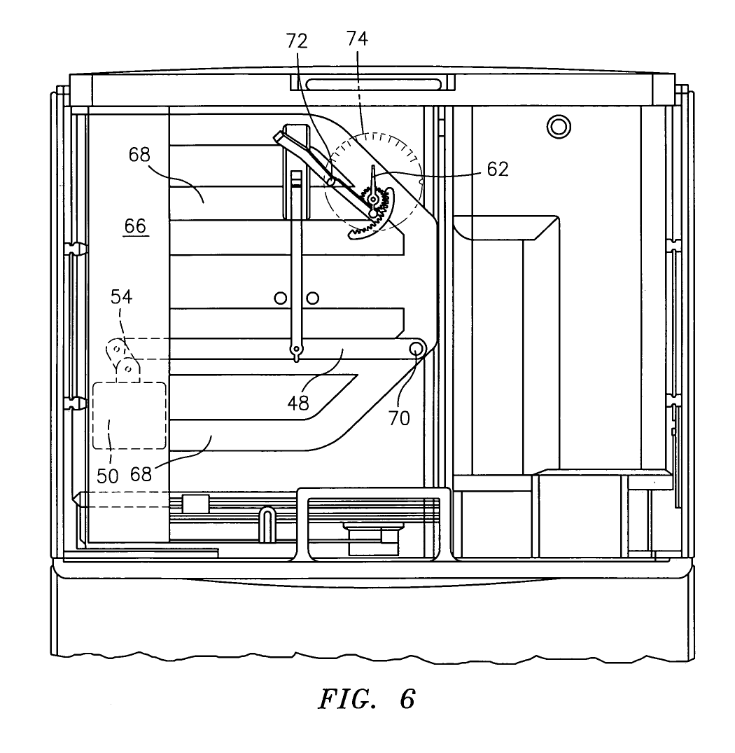

As shown in FIGS. 5 and 6, the indicator 24 is supported by a frame 64, which both supports the indicator 24 within the housing 12 and guides the float, only allowing for vertical movement of the float within a hollow post 66. The indicator 24 can be secured to a support plate 68 in part with a main hinge 70 about which the lever 48 pivots.

In operation, a user would open the lid 14 and place an amount of fresh water into the fresh water reservoir 26. The control panel 16 would be programmed to enable the coffee maker to prepare the coffee in a manner specified by the user. The water would flow from the fresh water reservoir 26 though a hole (not shown) in the bottom of the water reservoir 26 into a fresh water tube (not shown). The fresh water tube would carry the water from the water reservoir 26 through the water heater 36, where the water would be heated to a high temperature. The hot water tube 36 would carry the hot water to the pipe 38 and then onto the water spreader 30 via the arm 40. The hot water is then distributed to the filter basket 28 though the apertures 32 in the water spreader 30. The hot water mixes with the coffee grinds to produce coffee. The coffee drips through the basket opening 44 and into the brewed coffee reservoir 42. The heater plate 46 keeps the coffee hot until it is ready to be dispensed. To pour the coffee, a user would depress the actuator 20. The coffee would exit via the dispenser 18 into a cup or container to be consumed.

The coffee level indicator 24 would indicate the amount of brewed coffee within the coffee reservoir 42. As the coffee is brewed, the amount of coffee within the reservoir 42 would increase. This would cause the float 50 to rise on top of the coffee level. As the float 50 rises, the lever 48 pivots about the main hinge 70. This causes the first rod 58 to move vertically which, in turn, causes the second rod 60 to rotate about a rod hinge 72. This then causes the gears 56 to rotate, which rotates the indicator needle 62 within the gauge. A user can then read the amount of coffee remaining in the coffee reservoir 42 from the markings 74 on the indicator gauge 52. As coffee is dispensed from the coffee maker 10, the level of coffee within the coffee reservoir 42 decreases, causing the float 50 to move vertically downward. This causes the lever 48 to pivot in a downward direction, which indirectly causes the indicator needle 62 to rotate in the opposite direction.

The markings 74 on the indicator gauge 52 can be made to indicate a variety of different readings. For example, these can include a range from 0 to a certain maximum amount of coffee (e.g. the number of cups) contained in the coffee reservoir 42, or from E (empty) to F (full). The markings in between these levels can indicate, for example, the number of cups remaining, a percentage of coffee that remains or any other numerical indication of the amount of coffee remaining.

While a preferred embodiment of the invention has been herein disclosed and described, it is understood that various modifications can be made without departing from the scope of the invention.

What is claimed is:

1. A brewed beverage maker comprising:
a housing;
a water reservoir within said housing for holding water to be heated;
a water heater within said housing to heat said water;
a filter basket within said housing to hold beverage grinds to be brewed;
a brewed beverage reservoir for holding a brewed beverage;
a dispenser for dispensing said brewed beverage; and
a brewed beverage level indicator adapted to indicate the amount of said brewed beverage within said brewed beverage reservoir.

2. A brewed beverage maker according to claim 1, wherein
said brewed beverage level indicator comprises:
a float for floating on the surface of said brewed beverage;
a lever linked to said float and adapted to pivot about a first hinge when said float is displaced vertically; and
a gauge connected to said lever for displaying the amount of said brewed beverage in said brewed beverage reservoir in response to said vertical displacement.

3. A brewed beverage maker according to claim 2, wherein
said brewed beverage level indicator further comprises:
an indication needle within said gauge adapted to visually indicate a specific level marking in said gauge.

4. A brewed beverage maker according to claim 2, wherein
said brewed beverage level indicator further comprises:
a first rod connected to said lever and adapted to move in a vertical direction as said lever pivots about said first hinge;
a second rod connected to said first rod and having a second hinge wherein
said second rod is adapted to rotate about said second hinge in response to said vertical movement of said first rod; and
a gear system connected to said second rod and adapted to rotate said indication needle.

5. A brewed beverage maker according to claim 2, further comprising
a frame within said housing adapted to support said brewed beverage level indicator.

6. A brewed beverage maker according to claim 5, wherein
said frame further comprises a post adapted to guide said float in a vertical direction.

7. A brewed beverage maker according to claim 1, further comprising
a secondary heater in said brewed beverage reservoir adapted to keep said brewed beverage warm.

8. A brewed beverage maker according to claim 1, wherein
said water reservoir is adapted to be removable for cleaning.

9. A brewed beverage maker according to claim 1, wherein
said brewed beverage reservoir is adapted to be removable for cleaning.

10. A brewed beverage maker according to claim 1, further comprising
a control panel for operating said brewed beverage maker.

11. A brewed beverage maker according to claim 1, further comprising
a water spreader above said filter basket adapted to distribute said water into said filter basket.

12. A brewed beverage maker according to claim 1, further comprising
a removable drip tray adapted to receive brewed beverage that is spilled.

13. A liquid container comprising:
a reservoir for holding a liquid;
a dispenser for dispensing said liquid from said reservoir; and
a liquid level indicator adapted to indicate the amount of said liquid within said reservoir, wherein
said liquid level indicator comprises:
a float for floating on the surface of said liquid;
a lever linked to said float and adapted to pivot about a first hinge when said float is displaced vertically; and
a gauge connected to said lever for displaying the amount of said liquid in said reservoir in response to said vertical displacement.

14. A liquid container according to claim 13, wherein
said liquid level indicator further comprises:
an indication needle within said gauge adapted to visually indicate a specific level marking in said gauge.

15. A brewed beverage maker according to claim 13, wherein
said liquid level indicator further comprises:
a first rod connected to said lever and adapted to move in a vertical direction as said lever pivots about said first hinge;
a second rod connected to said first rod and having a second hinge wherein
said second rod is adapted to rotate about said hinge in response to said vertical movement of said first rod; and
a gear system connected to said second rod and adapted to rotate said indication needle.

16. A liquid container according to claim 13, further comprising
a frame within said reservoir adapted to support said liquid level indicator.

17. A liquid container according to claim 13, wherein
said frame further comprises a post adapted to guide said float in a vertical direction.
